(19) United States
(12) Patent Application Publication
(10) Pub. No.: US 2008/0067256 A1
(43) Pub. Date: Mar. 20, 2008

(54) PERSONALIZED CREDIT CARD AND METHOD OF PROMOTING CREDIT CARDS

(76) Inventor: Jo L. Shernaman, Columbia, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/850,003

(22) Filed: Sep. 4, 2007

Related U.S. Application Data
(60) Provisional application No. 60/824,460, filed on Sep. 4, 2006.

(51) Int. Cl. G06K 19/06; G06Q 90/00

(52) U.S. Cl. 235/493; 705/14

(57) ABSTRACT

A personalized credit card is provided that includes information traditionally found on the face of a credit card (i.e. card holder's name, credit card number, issuing bank name, credit card network logo, etc.) as well as design artwork that is personalized to the card holder and an identifier identifying the personal relationship of the personalized artwork to the card holder. A method of promoting credit cards is provided in which a cardholder is offered the ability to apply for a personalized card at the time the card holder purchases a motorcycle from the motorcycle dealer, and in which the motorcycle dealer is offered an incentive by an issuing bank for offering the card holder the ability to apply for the card.

### CROSS-REFERENCE TO RELATED APPLICATIONS

This application claims priority pursuant to 35 U.S.C. 119(e) to co-pending U.S. Provisional Patent Application Ser. No. 60/824,460, filed Sep. 4, 2006, the entire disclosure of which is incorporated herein by reference.

### FIELD OF THE INVENTION

The present invention relates generally to credit cards (including ATM cards, debit cards, gift cards and the like). More particularly, the present invention is concerned with credit cards that are uniquely personalized for the card holder.

### BACKGROUND OF THE INVENTION

It is known to include a credit card holder's photo on the face of the holder's credit card for security identification purposes. It is also known to allow a credit card holder to place a personal digital photo onto the face of his/her card. While these alternatives do allow the card holder some ability to personalize the design of his/her credit card, they provide several disadvantages. The use of a card holder's picture of himself/herself, or the use of a digital photo owned by the card holder, requires that the card holder provide the photo to the credit card company so that it may be placed on the card. Alternatively, some credit card companies offer credit card holders with an array of stock designs from which the card holder may make a selection. Although this alternative does not require the card holder to provide a photo to the credit card company, it does limit the card holder's ability truly to personalize the card to himself/herself. Therefore, it would be beneficial to provide a way for card holders fully to personalize a credit card design without the need to provide his/her own photograph or artwork.

In the credit card industry, there is significant competition, not just to get cards in the hands of consumers, but to induce card holders to use a particular card, as opposed to just whatever card is the handiest. So, card issuers and credit card networks offer numerous “promotions” to induce use of their particular cards such as cash rebates, discounts, and incentive points such as redeemable coupons or so-called frequent flier miles. These all are costly and require complex personnel-intensive mechanisms to administer. No credit card network or card issuer has been able imaginatively to capture and capitalize upon the card holder's particular psychological profile or, in some cases, “machismo” as a use-inducing incentive without simultaneously offering a costly card holder remunerative feature, let alone employ a method that harnesses the card holder's psychological profile so as to make it remunerative (not costly) to induce use of the particular card.

### SUMMARY OF THE INVENTION

A principal object of the instant invention is to provide a credit card (including ATM cards, debit cards, gift cards and the like) that is uniquely personalized for the card holder. Another object of the instant invention is to provide a way for card holders fully to personalize a credit card design without the need to furnish their own photographs or artwork. Another object of the instant invention is a method of promoting credit cards use. Another object of the instant invention is a method of promoting credit card use without the need for costly “rewards” programs and without the need for an elaborate administrative infrastructure. Still another object of the instant invention is to provide a method of promoting credit card use that capitalizes upon card holder's particular psychological profiles so as to generate revenue rather than increase costs for card issuers and credit card networks.

The objects of the instant invention are accomplished through the use of a credit card that includes information traditionally found on the face of a credit card (i.e. card holder's name, credit card number, issuing bank name, credit card network logo, etc.) as well as design artwork that is personalized to the card holder and an identifier identifying the personal relationship of the personalized artwork to the card holder. The artwork is customized for the card holder based upon selections made by the card holder as he/she applies for the card.

The objects of the instant invention are further accomplished through a method in which a cardholder is offered the ability to apply for a personalized card at the time the card holder purchases a motorcycle from the motorcycle dealer, and in which the motorcycle dealer is offered an incentive by an issuing bank for offering the card holder the ability to apply for the card.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a drawing of a credit card of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

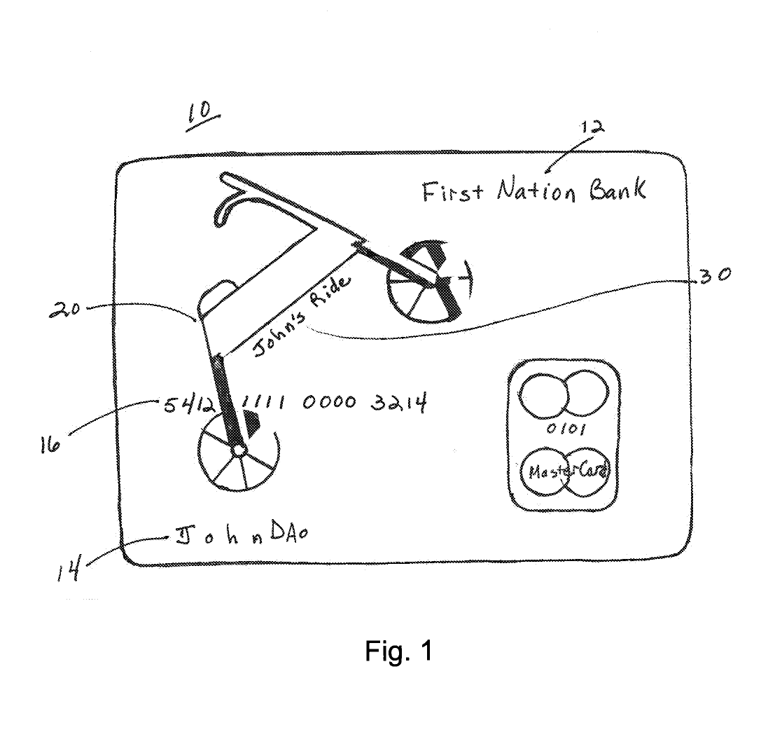

Referring to FIG. 1, a preferred embodiment of a credit card of the instant invention is shown. Credit card 10 includes traditional card information, including card holder's name 14, credit card number 16, issuing bank name 12, credit card network logo 18. In addition, credit card 10 includes artwork 20 that has been customized for the card holder, and identifier 30 identifying the personal relationship of artwork 20 to the card holder.

In the preferred embodiment of credit card 10 shown in FIG. 1, artwork 20 is artwork that represents a motorcycle that is owned by the card holder. In the preferred embodiment, the card holder is offered the ability to apply for the personalized card at the time the card holder purchases the motorcycle from the motorcycle dealer. In a preferred embodiment the motorcycle dealer is offered a financial incentive by the issuing bank for every credit card application that the dealer solicits. The incentive may be in the form of a monetary payment for each application solicited, or may even be in the form of a percentage of revenues generated by credit card usage fees and/or finance charges obtained as a result of the card holder's usage of the card.

At the time the card holder purchases a motorcycle and applies for the card, the card holder is allowed to select artwork that is representative of the motorcycle being purchased. The artwork may be stock artwork of the dealer or credit card company, or may be a personalized picture that is taken of the actual motorcycle being purchased (i.e. of the motorcycle and the card holder together). If the artwork is stock artwork, the card holder may be allowed to select from a variety of independent pieces of artwork (such as photos) that are related to each other. The selections may include a variety of colors and other options for the model of motorcycle being purchased from the card holder. In addition, the selections may allow the card holder to choose from a variety of backgrounds or settings in which the motorcycle is displayed (i.e. mountains, street, showroom, etc.). This allows the card holder to select artwork that is particularly representative of the card holder's psychological profile (or image the card holder wants to project) and the particular motorcycle being purchased.

In addition to the personalized artwork, 20, the card 10 of the instant invention also includes identifier 30 that identifies the personal relationship of the card holder to the motorcycle depicted in artwork 20. For example, in FIG. 1 identifier 30 shows the phrase “John's ride” for the card holder John A. Doe. This phrase allows any viewer of card 10 to recognize that the motorcycle depicted in artwork 20 is either the card holder's motorcycle or a representation of the motorcycle owned by the card holder. In a preferred embodiment, the card holder is allowed to customize the phrase that is printed on the card to reflect the card holder's personality.

In one embodiment of card 10 shown in FIG. 1 that involves the use of stock artwork, the card holder is allowed to create an electronic depiction of the card holder's desired card at the time of application. This can be accomplished onsite (such as at the motorcycle dealership) through a stand-alone software application, or at a remote location through a web-based software portal. It will be appreciated that a web-based portal could also be utilized onsite (i.e. at the motorcycle dealership). In the context of an application made at a motorcycle dealership, or by a card holder that has just purchased a motorcycle, the software will first require the cardholder to select the model of motorcycle purchased. Then the software will prompt the card holder to select the color and other options on the motorcycle. As the card holder selects the model, color and other options, artwork 20 will be updated to reflect the selections and will be displayed on the computer screen in a template for card 10. The card holder will then be prompted to select a background for the card, and when the selection is made, the template will again be updated. Next the card holder will be prompted to create identifier 30 by typing in a phrase for display on the card. Once the card holder enters the phrase, the card holder is displayed the completed depiction of card 10 and the application is submitted. In a preferred embodiment, the entire credit card application is completed and submitted electronically, including the application for credit and the personalization of artwork 20 and identifier 30, as a single application; however, it will be appreciated that the application for credit can be accomplished through a separate process (which may or may not be electronic) from the personalization of card 10.

In an alternative embodiment, of card 10 shown in FIG. 1 that involves the use of stock artwork, the card holder creates the personalized artwork, 20, and identifier 30 through a traditional paper form. In this embodiment the card holder fills out a form that includes a number of inquiries. In the context of a card involving a motorcycle, the first inquiry is the make and/or model of the motorcycle. The inquiry can provide a number of options from which the card holder selects the option most appropriate, or alternatively it can provide a blank space to allow the card holder to write in the selection. The next inquiry is color and then other options. These too can be lists of options or fill in the blank. Then the user is allowed to select a background. The various background options can be displayed on the form or otherwise described. Finally, the form will include an inquiry for the user to select (or write in) the desired identifier 30. This paper form is then submitted with or as a part of the credit card application.

It will be appreciated that the instant invention is not limited to that of the preferred embodiment. For example, the instant invention can be utilized to display various types of products, including other motor vehicles (such as trucks, automobiles, boats, ATVs, or personal watercraft), stereos, personal residences, etc. that the card holder believes to be indicative of the card holder's personality, and the cards can therefore be offered by any type of suppliers or other sellers of items which can be displayed or depicted on the card.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A credit card comprising:
a card holder information;
an artwork customized to the card holder;
an identifier identifying a personal relationship of said artwork to the card holder.

2. The credit card as claimed in claim 1 wherein said artwork represents a motorcycle purchased by the card holder.

3. The credit card as claimed in claim 2 wherein said artwork comprises a photograph of the card holder's actual motorcycle.

4. The credit card as claimed in claim 2 wherein said artwork comprises stock artwork depicting a motorcycle similar to the card holder's actual motorcycle.

5. The credit card as claimed in claim 4 wherein said stock artwork is selected from artwork comprising motorcycles of multiple colors.

6. The credit card as claimed in claim 4 wherein said stock artwork is selected from artwork comprising motorcycles having multiple different options.

7. The credit card as claimed in claim 4 wherein said stock artwork is selected from artwork comprising multiple different backgrounds.

8. The credit card as claimed in claim 1 wherein said identifier comprises a phrase printed on the card in proximity to said artwork.

9. A method of promoting a personalized credit card, said method comprising:
selling a card holder a motorcycle;
offering said card holder the ability to apply for a credit card at the same time said card holder is purchasing said motorcycle; and
providing a motorcycle dealer that is selling said card holder said motorcycle an incentive for said offering of said card holder the ability to apply for said credit card.

10. The method as claimed in claim 9 wherein said incentive comprises a monetary payment for each application solicited.

11. The method as claimed in claim 9 wherein said incentive comprises a percentage of revenues generated by credit card usage fees and/or finance charges obtained as a result of said card holder's usage of said credit card.

12. The method as claimed in claim 9 further comprising the step of allowing said card holder to select artwork for inclusion on said credit card, wherein said artwork is representative of said motorcycle.

13. The method as claimed in claim 12 wherein said artwork comprises a photograph of the card holder's actual motorcycle.

14. The method as claimed in claim 12 wherein said artwork comprises stock artwork depicting a motorcycle similar to the card holder's actual motorcycle.

15. The method as claimed in claim 12 further comprising the step of allowing said card holder to select an identifier for inclusion on said credit card, said identifier identifying a personal relationship of said artwork to the card holder.

16. A method of promoting personalized items, said method comprising:
selling a purchaser an object;
offering said card holder the ability to obtain items from a provider separate from the seller of said object at the same time said purchaser is purchasing said object, wherein said items include artwork that is representative of said object; and
providing the seller of said object an incentive for said offering of said purchaser the ability to obtain said items.

17. The method as claimed in claim 16 wherein said object is a motorcycle.

18. The method as claimed in claim 16 wherein said item comprises a credit card for which said purchaser may apply.
